(19) United States
(12) Patent Application Publication
(10) Pub. No.: US 2008/0114699 A1
(43) Pub. Date: May 15, 2008

(54) SYSTEM, HARDWARE AND METHOD FOR MOBILE POS PAYMENT

(76) Inventors: GONG YI YUAN, HONG KONG (HK); GARY LEBOWITZ, DARBY, MT (US)

Correspondence Address: GONG YI YUAN, UNIT F, 21/F CNT TOWER, 326-338 HENNESSY ROAD, WANCHAI, HONG KONG, omitted

(21) Appl. No.: 11/927,382

(22) Filed: Oct. 29, 2007

Related U.S. Application Data
(60) Provisional application No. 60/858,297, filed on Nov. 13, 2006.

(51) Int. Cl. G06Q 20/00; H04L 9/00

(52) U.S. Cl. 705/78; 235/375; 705/17; 705/18; 705/21

(57) ABSTRACT

The present invention provides a system, hardware and method for mobile payment via a low-cost simple POS station and a mobile device. A general objective of the invention is to process payment authorization via the mobile consumer's own mobile device and mobile network, instead of the POS network's backbone.

### FIELD OF INVENTION

This invention relates to payment authorization at point-of-service (POS) by a mobile user's own mobile device and network.

### BACKGROUND

1. Field of the Invention

POS transactions have been around for a long time. Among the most common and traditional POS transactions consumers have experienced are credit card and debit card transactions at retail outlets. Cash-value cards are getting widely adopted, most commonly used for public transportation and micro-payments at retail outlets. A lot of these cards are becoming “contactless”, powered by RFID or similar technologies. Latest technological advances are allowing “cardless” POS transactions, using recognition technologies to identify the consumers by their voices, face or fingerprints.

Regardless of the type of POS transaction, POS terminals today are configured to connect directly by wire and/or wireless connection to the payment-processing or authorization center and the payment authorization process is done via the network behind the connected POS terminals. This results in reduced mobility and flexibility of the POS terminals and increased costs of the installation and connection of the POS terminals, and costs of the terminals themselves.

2. Description of the Prior Art

Mobile payment systems are well known in the art, such as that described in U.S. Pat. No. 7,039,389 to Johnson, Jr., U.S. Patent Application No. 20030004797 to Villaret, and U.S. Patent Application No. 20050222961 to Staib. These references disclose payment authorization systems which communicate directly with a user's mobile device. However, the payment authorization systems also communicate directly with the merchant POS terminal to transmit transaction information.

U.S. Pat. No. 6,868,391 to Haltgren and U.S. Patent Application No. 20070108269 to Benco et al. disclose mobile payment systems in which a merchant POS terminal transmits transaction information to a mobile device, which in turn transmits the transaction information to a payment authorization system. However, in these references, the payment authorization system communicates an approval or rejection directly to the merchant POS terminal, bypassing the mobile device.

This invention shifts the connection to the payment-authorization center from the POS terminal to the mobile user's own mobile device and mobile network for payment processing or authorization, thus allowing portable and low-cost POS stations. The payment request is sent to the mobile device from the merchant POS terminal, and an approval or rejection signal is sent to the mobile device from the payment authorization system. In this way, the mobile device is a portable POS station which acts as a go-between the merchant POS terminal and payment authorization system.

### SUMMARY OF THE INVENTION

A general objective of the invention is to process payment authorization via the mobile consumer's own mobile device and mobile network, instead of the POS network's backbone.

Another objective is to create a portable POS station that does not require to be directly connected, by wire or wireless connection, to the payment-authorization center.

Another objective is to allow easy POS mobile payment authorization via unmodified mobile devices.

Another objective is to reduce the costs and complexity of the POS station.

The present invention provides a mechanism for mobile payment via a low-cost simple POS station and a mobile device.

In accordance with the invention, for a POS transaction to take place, the consumer as the mobile user, first registers their SIM card (or equivalent UICC or RUIM) with a payment service, such a commercial bank or credit card issuing bank. The mobile user can also register a personal identification code (PIN) with the payment service to be used to verify the mobile user during payment requests. Likewise, the POS merchant or payee also registers with a payment service in order to receive the payment, such that the merchant's POS machines carry the merchant's identity.

In accordance with one embodiment of this invention, to activate and operate the portable POS, the mobile user installs a user interface to the mobile device for facilitating payment transactions on the mobile device. The user interface can be installed by download to a mobile device memory, either via a mobile network or via a hard wire programming at a service center.

In accordance with another embodiment of this invention, when a mobile user is to initiate a payment to a POS station, the mobile user will enter or dial a sequence of numbers and/or characters, e.g. *888, on his/her mobile device. The mobile network will then connect the call to a payment-authorization center. While the mobile user is connected to the payment- authorization center, a plurality of signals will be exchanged between the mobile device and the POS station, thus allowing the mobile device to send and receive the required information for payment authorization via the mobile network to the payment-authorization center.

Additional objects, advantages and novel features of the invention will be set forth in part in the description which follows, and in part will become apparent to those skilled in the art upon examination of the following and the accompanying drawings or may be learned by practice of the invention.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a functional block diagram of a mobile network, capable of implementing the communications in accord with the present invention.

FIG. 2 is a functional block diagram of a mobile network and the POS station capable of implementing the communications in accord with the present invention.

FIG. 3 is a flow chart of a preferred process of the present invention.

FIG. 4 is a functional block diagram of a POS station for use in a network of the type shown in FIG. 1.

FIG. 5 is a functional block diagram of a POS station for use in a network of the type shown in FIG. 1.

### DETAILED DESCRIPTION OF THE PREFERRED EMBODIMENTS

Reference is now made in detail to the presently preferred embodiments of the inventions, examples of which are illustrated in the accompanying drawings, wherein like reference numerals indicate like elements throughout the several views.

In a preferred embodiment, the mobile network comprises a base station controller (BSC) 11, a plurality of base stations 13 and a plurality of mobile devices 15. Examples of these mobile devices include, but are not limited to, cellular phones, wireless communication devices, laptop computers, palm-sized computing devices, personal digital assistants (PDAs), and pagers. Although in a preferred embodiment of this invention the mobile network consists of a cellular network, one skilled in the art will understand that this invention may utilize a variety of mobile networks, including, but not limited to, satellite networks and wireless networks.

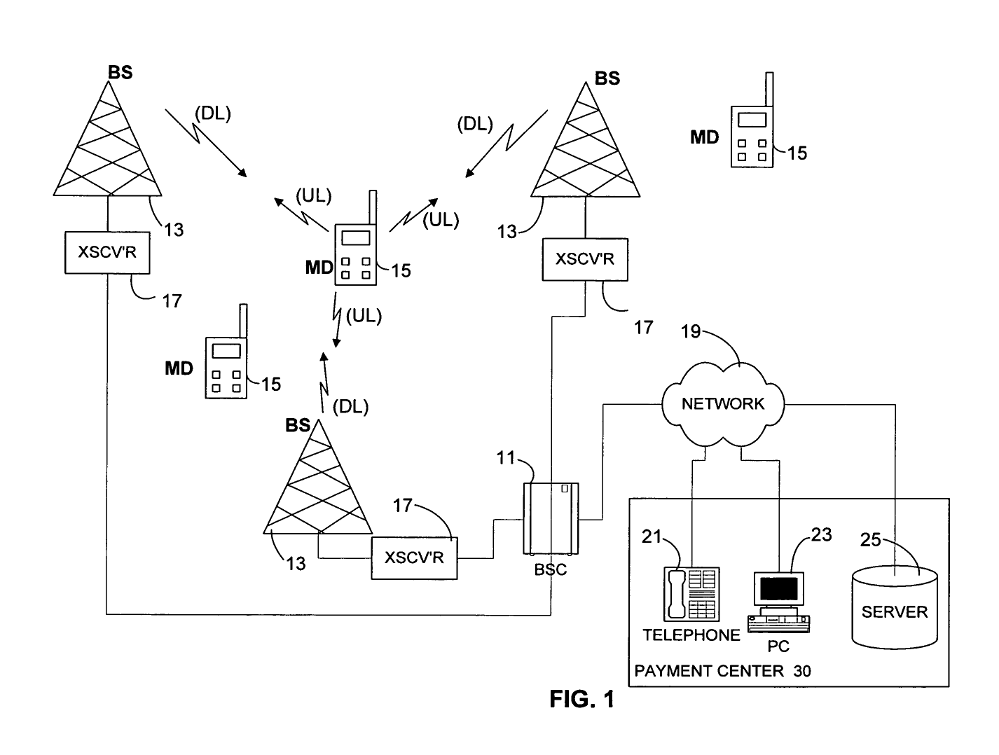

FIG. 1 shows a simplified functional block diagram of a mobile network providing two-way communications. With reference to FIG. 1, each base station (BS) 13 has a transmitter and a receiver, shown as a single transceiver (XSCV'R) system 17 for simplicity in this drawing. Each mobile device (MD) 15 has a transmitter and a receiver (not separately shown). In a typical embodiment, the base station controller (BSC) 11 provides two-way communications to a network, shown by way of example as a network 19. The BSC 11 and the network 19 provide the MD units 15 with two-way communications services to enable communication to and from the payment-authorization center 30 via certain devices, represented by way of example by the telephone 21 (or IP telephone), the personal computer (PC) 23 and the server 25.

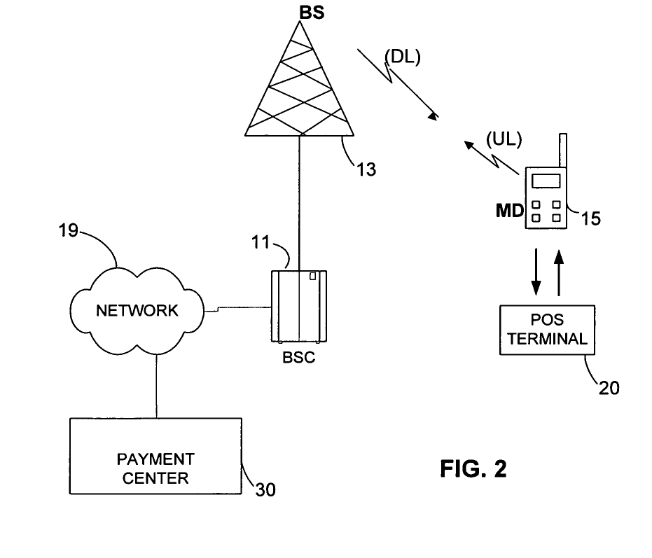

FIG. 2 illustrates a preferred embodiment of the invention. In accord with the invention, a mobile connection has been set up between a MD 15 and BS 13, which provides two-way communications between MD 15 and payment-authorization center 30 via BSC 11 and network 19. The MD 15 is in close proximity to POS station 20, exchanging a series of signals by any different possible ways (e.g. short-range communication, audio, voice, etc). While MD 15 is in communication with payment-authorization center 30, MD 15 receives a first signal containing information about the payee (e.g. POS ID and amount to be paid) from the POS station 20 and transmits such information to payment-authorization center 30 via the mobile network. Payment-authorization center 30 uses such information and the ID of the MD 15 to process and authorize payment. After processing, the payment-authorization center 30 generates a second signal containing an authorization or confirmation, which will be sent to MD 15 via BS 13. MD 15 receives the second signal containing the authorization or confirmation and transmits to POS station 20. The mobile POS transaction is then completed, and the call will be terminated.

Preferably, for security purpose, the signals being transmitted between MD 15 and BS 13 are generated in a random manner and the transmissions are encrypted. At the end of transaction, the POS station can also remit a signal audible or visible by the mobile user to indicate that the transaction was successful.

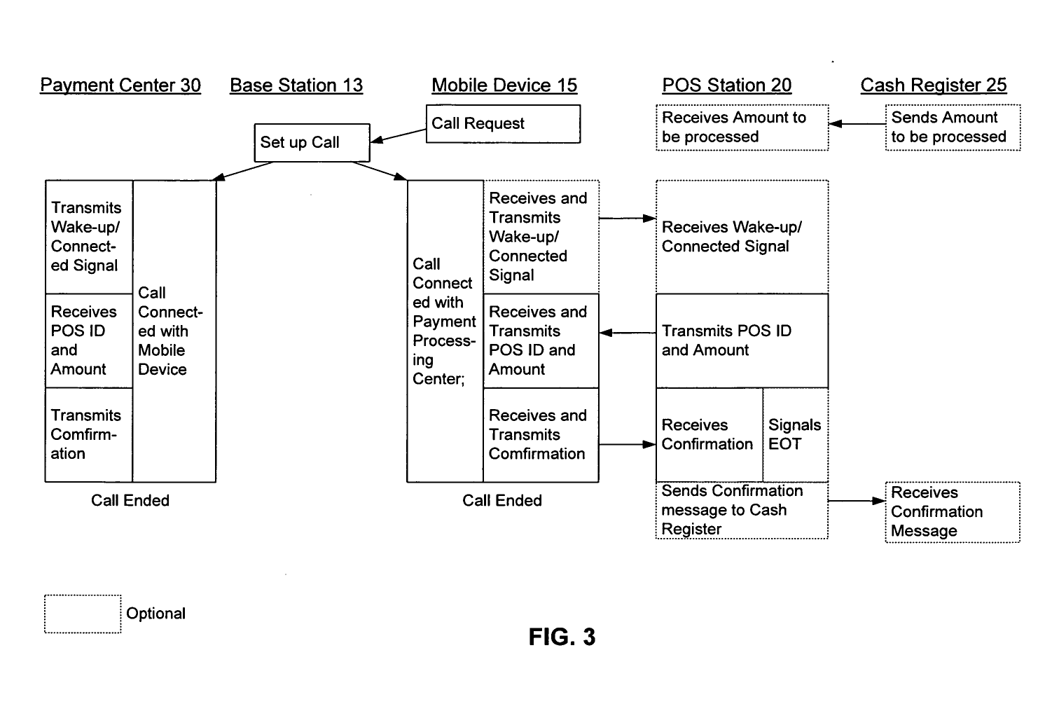

FIG. 3 illustrates a presently preferred process/method of the invention. The dotted line boxes indicate optional steps of the process/method. Most commonly, a POS sale is rung up at a cash register 25 (or similarly functioned retail network terminal such as a kiosk, computer, vending system, or another mobile device), which is connected to a POS station 20. The total amount to be charged is sent by the cash register 25 to the POS station 20. For POS transactions that do not involve the use of a cash register, the payment amount can be directed inputted by the merchant/payee to the POS station 20.

In accordance with one embodiment of this invention, when the mobile user is, ready to make payment, the mobile user enters a sequence of numbers/characters (as in dialing) in MD 15, which prompts a call request by MD 15 to base station 13. Receiving the call request, the base station 13 sets up a call between the MD 15 and payment-authorization center 30. The call request needs not be triggered by the mobile user but is preferred to be in this embodiment for security reasons. For example, the MD 15 can be configured to automatically send a call request upon receiving certain signals from the POS station.

While the call between the MD 15 and the payment-authorization center 30 is connected, the phone is in proximity with the POS station 30. A plurality of signals will be exchanged between the MD 15 and the POS station 20 through various methods, including but not limited to voice, image and radio frequency transmissions (e.g. RFID or Bluetooth), thus allowing the MD 15 to send and receive the required information for payment authorization via the mobile network to the payment-authorization center 30.

While the call between the MD 15 and the payment-authorization center 30 is connected, the POS station 20 transmits at least one payment-request-signal containing its POS ID (or merchant/payee ID) and the amount of payment to the MD 15, which receives and transmits the payment-request-signal to payment-authorization center 30 via the base station 13 and the mobile network. Payment-authorization center 30 receives the payment-request-signal and processes the payment authorization with the information of the caller, normally from the caller's SIM card, and the information contained in the payment-request-signal. The payment-request-signal can be repeated or be recurring so as to eliminate possible transmission errors.

If the payment is approved, payment-authorization center 30 transmits an approval-signal containing/signifying the approval of such payment. MD 15 receives the approval-signal and transmits the same to POS station 30. The POS station receives the approval-signal and the payment authorization process is completed. The POS station may be configured to produce an audio and/or visual indication such that the mobile user and the cashier can be aware that the transaction is successful and completed.

If the payment is denied, payment-authorization center 30 transmits a reject-signal containing/signifying the rejection of such payment. MD 15 receives the reject-signal and transmits the same to POS station 20. The POS station receives the reject-signal and the payment authorization process is completed. The POS station may be configured to produce an audio and/or visual indication such that the mobile user and the cashier can be aware that the transaction is failed.

Preferably, the approval-signal and reject-signal contains reference number unique to that transaction. The POS station may store the reference number in its memory or pass that on to the cash register 25 if connected. The approval-signal and reject-signal can also set to be repeated so as to reduce possible transmission errors. After sending of the set number of approval-signal(s) or reject-signal(s), the payment-authorization center 30 disconnects the call.

If, within a certain defined period of time, the payment-authorization center 30 did not receive any signal, a time-out occurs, upon which the payment-authorization center 30 will terminate the call.

If, within another certain defined period of time, the POS station 20 does not receive any signal, a time-out occurs, upon which the POS station 20 will display a visual or audio sign to indicate that the payment request failed or request the merchant/payee and mobile user to try again.

Depending on the type of transmission used between MD 15 and POS station 20, the payment-request-signal sent by the POS station 20 to the MD 15 may be the identical to or different from the payment-request-signal sent by the station 15 to payment processing center 30. Likewise, the approval and reject-signal from the payment-authorization center 30 to MD 15 may be the identical to or different from the approval and reject-signal being sent to the POS station 20. Even when they are different in form, the nature shall remain the same.

In another preferred embodiment, once the call between the MD 15 and the payment-authorization center 30 is connected, prior to receiving the payment-request-signal, the payment-authorization center 30 starts transmitting a connection-signal to the MD 15 signifying the connection being successfully set-up. The MD 15 receives the connection-signal and transmits the connection-signal to the POS station 20. The connection-signal can act also as the “wake-up” signal if the POS station 20 is in “sleep mode” or simply be a “start-command”. The connection-signal may also contain a reference number identifying that payment request and can be repeated or be recurring. If the connection-signal contains a reference number already, the approval or reject-signal need not contain the same information.

In yet another preferred embodiment, as soon as the payment authorization process is initiated, the POS station 20 repeatedly transmits the POS ID and amount information while the payment-authorization center 30 repeatedly transmits a connection-signal comprising a reference number as soon as the call is set up. In this embodiment, the waiting time is eliminated and error can be reduced. As soon as the payment authorization is complete, a short approval-signal or reject-signal is sent by the payment-authorization center 30 to the POS station 20 via the MD 15.

When transactions involve higher amount for payment, additional security and verification processes commonly known in the art can be introduced. For example, the mobile user will have to enter his/her password into the phone during the transaction, or the POS station can print out a slip for signature as in current common credit card POS transactions.

In another security and verification process, the mobile user enters, either manually or verbally, a PIN into the MD 15. The MD 15 transmits the PIN to the payment-authorization center 30. The payment-authorization center 30 then verifies the mobile user by matching the PIN to a stored identification code entered by the mobile user during the registration process. If verification of the PIN is successful, the transaction process continues. If the verification of the PIN is unsuccessful, the transaction process terminates, and the payment-authorization center 30 generates a reject-signal and transmits the reject-signal to the MD 15.

The invention can also support other current or future forms of payment using the consumer's mobile device for authorization purpose. The POS station 20 can be equipped with a card reader, for swiping a credit/debit card, and sends such information along with the POS ID and amount to the MD 15 to be sent to the payment-authorization center 30. Likewise, the POS station can be equipped with a fingerprint reader, for identifying the mobile user, and sends such information along with the POS ID and amount to the MD 15 to be sent to the payment-authorization center 30. Voice recognition is another option to be performed at the phone or the POS station.

### POS Station

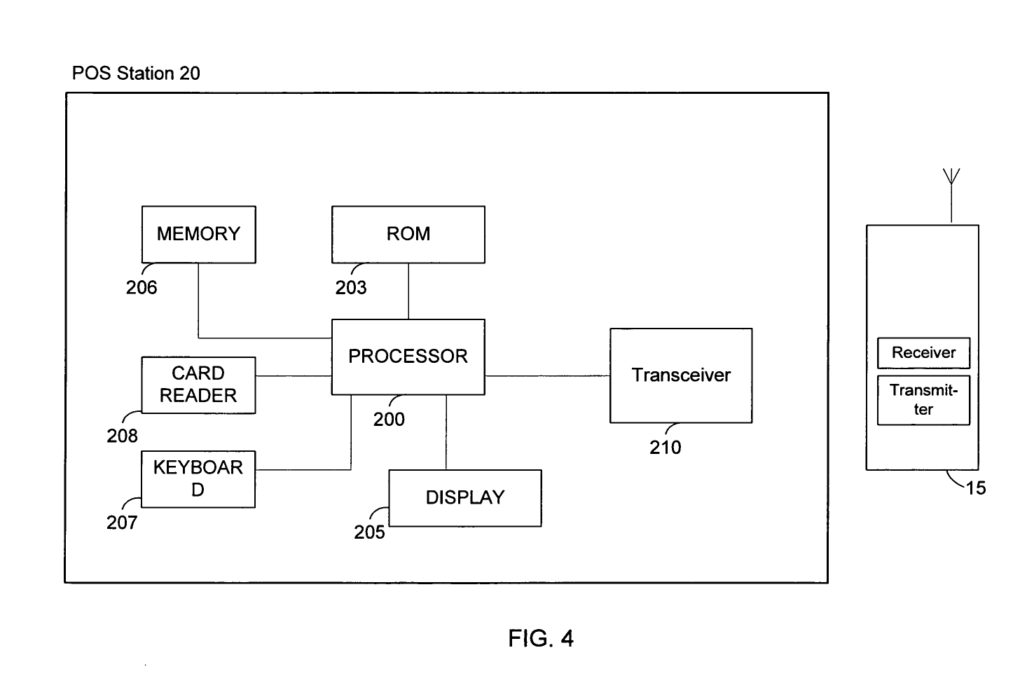

FIG. 4 illustrates a POS station 20 capable of implementing the transactions in accord with the present invention. The POS station includes a receiver and transmitter, shown together as a single transceiver 210, for receiving and transmitting signals with MD 15. The transceiver 210 is coupled to a processor 200 that is coupled to a read-only memory 203, for storing a unique ID for the POS station 20 that identifies the merchant/payee. The processor 200 is coupled to a display 204, displaying information to merchant/payee and mobile users. Optionally, the POS station 20 can include memory 206, for storing records of the transactions; keypad 207, for manual input by merchant/payee; card reader 208, for reading cards; and printer, for printing transaction records. POS station 20 may be connected to a cash register 25 or the merchants' retail network. The POS station can be operated by battery, A/C or D/C power (not shown).

In accord with the invention, when the MD 15 is being connected to payment-authorization center 30 and in proximity with POS station 20, processing 200 causes the transceiver 210 to transmit a signal containing the POS ID stored in ROM 203 and the amount for payment-authorization, which could be manually inputted or received via cash register 25. Upon receiving an approval-signal or a reject-signal via the transceiver, the processor 200 may record the transaction to memory 206 and display the transaction result on display 205, or causes the POS station to make an audio or other visual indications with speaker or light to indicate the result of the payment process.

### Acoustic POS Station

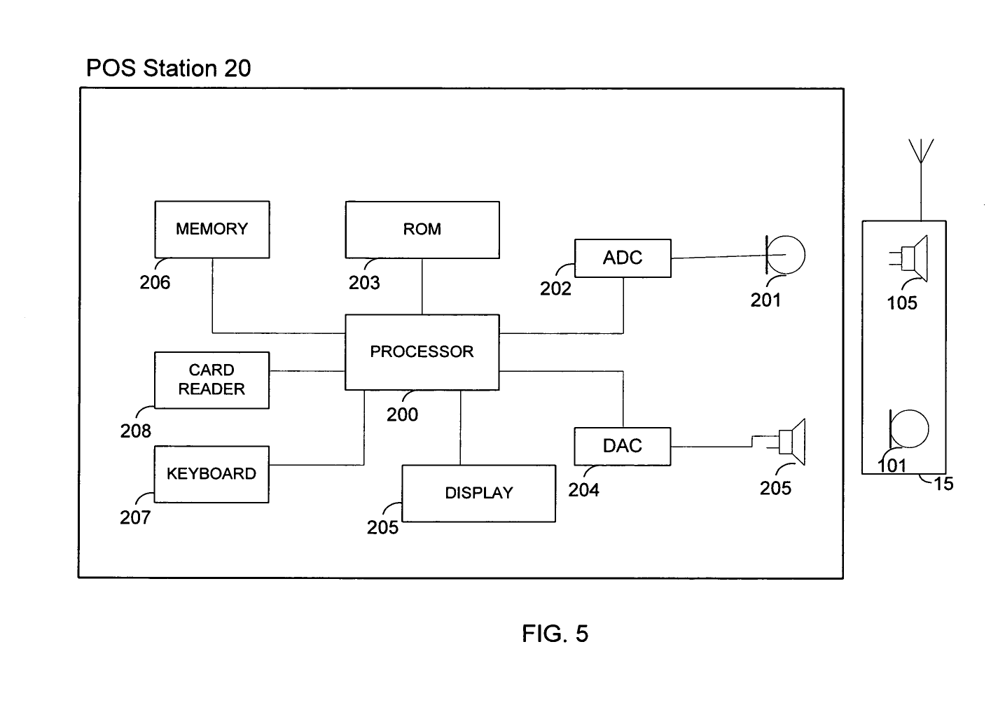

FIG. 5 illustrates a POS station 20 capable of implementing the transactions in accord with the present invention. The POS station includes a microphone 201, coupled to an analog-to-digital converter 202, and a speaker 205, coupled to a digital-to-analog converter 204. The converters 202 and 204 are coupled to a processor 200 that is coupled to a read-only memory 203 and a display 204. The read-only memory 203 contains a unique ID for the POS station 20, identifying the merchant/payee. Optionally, the POS station 20 can include memory 206, keypad 207, card reader 208 and printer and can be connected to a cash register or the merchants' retail network. The POS station can be operated by battery, A/C or D/C power (not shown).

In accord with the invention, when a mobile user is to initiate a mobile payment, the mobile user will dial a sequence of number/characters, e.g. *888, from the MD 15 and then place the phone 15 onto the POS station 20 such that the microphone 101 of the MD 15 is placed right in front of the speaker 205 of the POS station 20 and the speaker 105 of the MD 15 is placed in front of the microphone 201 of POS station 20.

The call is routed to a payment-authorization center 30 by the mobile network. Therefore, while the MD 15 is being connected to payment-authorization center 30, the POS station 20 will be able to “hear” and thus receive what is transmitted to the MD 15 from the payment-authorization center 30 via the speaker 105. Conversely, the payment-authorization center 30 can “hear” and thus receive what is transmitted by the POS station 20 via the microphone 101 of the MD 15.

With the above set-up, a series of signals can be exchanged between the payment-authorization center 30 and the POS station 20 to all for payment authorization. In a preferred embodiment, there are at least two signals to be exchanged: (1) The POS station 20 will send a payment-request-signal comprising its unique POS ID and the amount to be paid to its speaker 205, which via the microphone 101 of the MD 15 and the mobile network, will be received by the payment-authorization center 30; and (2) The payment-authorization center 30 will send an approval-signal or reject-signal, preferably with a reference number, that the payment will be made from the mobile user to the account associated with the unique POS ID, such approval-signal or reject-signal will be received by the POS station 20 via the speaker 105 of the mobile device.

Optionally, additional signals can be sent from the payment-authorization center 30 at the beginning to “wake up” the POS station 20, or to indicate the start of the payment-process. The additional signals can be recurring up until the confirmation signal, as a mechanism to eliminate errors in the process.

While the foregoing description includes many details and specifications, it is to be understood that these have been included for purposes of explanation only, and are not to be interpreted as limitations of the present invention. Many modifications to the embodiments described above can be made without departing from the spirit and scope of the invention, as is intended to be encompassed by the claims and their legal equivalents.

1. An electronic payment system comprising:
a mobile network;
a mobile device configured to receive a first signal from a point-of-sale station,
the mobile device further configured to transmit the first signal to a payment-authorization center via the mobile network, and further configured to receive a second signal from the payment-authorization center via the mobile network and transmit the second signal to the point-of-sale station;
the point-of-sale station configured to send the first signal to the mobile device;
a payment-authorization center configured to receive the first signal from the mobile device via the mobile network,
the payment-authorization center further configured to generate the second signal based on the first signal and transmit the second signal to the mobile device via the mobile network.

2. The system of claim 1 wherein the first signal includes a point-of-sale station identifier and a transaction amount.

3. The system of claim 1 wherein the mobile device receives the first signal from the point-of-sale station via at least one of a short-range communication method, an audio communication, or a visual communication.

4. The system of claim 1 wherein the mobile device is configured to store a user interface to facilitate the first signal.

5. The system of claim 1 wherein the mobile device is further configured to transmit a mobile device identifier along with the first signal to the payment-authorization center.

6. The system of claim 1 wherein the mobile network is a cellular network.

7. The system of claim 1 wherein the payment-authorization center is configured to transmit a transaction reference number to the mobile device.

8. A mobile point-of-sale authorization method, comprising the steps of:
transmitting, by a point-of-sale station, a first signal containing at least a point-of-sale station identifier and a transaction amount to a mobile device;
receiving, at the mobile device, the first signal;
transmitting, by the mobile device, via a mobile network, the first signal to a payment-authorization center;
receiving, at the payment-authorization center, the first signal;
verifying, by the payment-authorization center, the first signal;
authorizing, by the payment-authorization center, a transaction based on the first signal;
transmitting, by the payment-authorization center, via the mobile network, a second signal to the mobile device;
receiving, at the mobile device, the second signal;
transmitting, by the mobile device, the second signal to the point-of-sale station.

9. The method of claim 8, further comprising the step of encrypting, by the mobile device, the first signal, prior to transmitting the first signal to the payment-authorization center.

10. The method of claim 9, further comprising the step of decrypting, by the payment-authorization center, the first signal, prior to verifying the first signal.

11. The method of claim 8, further comprising the step of encrypting, by the payment-authorization center, the second signal, prior to transmitting the second signal to the mobile device.

12. The method of claim 11, further comprising the step of decrypting, by the mobile device, the second signal, prior to transmitting the second signal to the point-of-sale station.

13. The method of claim 8, further comprising the step of transmitting, by the payment-authorization center, a transaction reference number to the mobile device.

14. The method of claim 8, further comprising the step of transmitting, by the mobile device, a connection signal, to the point-of-sale station.

15. The method of claim 14, further comprising the step of transmitting, by the point-of-sale station, the first signal, to the mobile device, upon receipt of the connection signal by the point-of-sale station from the mobile device.

16. A mobile device for payment processing comprising:
a receiver configured to receive a first signal from a point-of-sale station,
the receiver further configured to receive a second signal from a payment-authorization center;
a transmitter configured to transmit the first signal to the payment-authorization center,
the transmitter further configured to transmit the second signal to the point-of-sale station;
an encryption means configured to encrypt the first signal; and
a decryption means configured to decrypt the second signal.

17. The mobile device of claim 16, wherein the mobile device is configured to communicate with point-of-sale station via a short-range communication method.

18. The mobile device of claim 16, wherein the mobile device is configured to communicate with the payment-authorization center via a mobile network.

19. The mobile device of claim 16, wherein the mobile device is further configured to receive a personal identification code from a mobile user.

20. The mobile device of claim 19, wherein the mobile device is further configured to transmit the personal identification code to the payment-authorization center.

21. A mobile point-of-sale authorization method, comprising the steps of:
receiving, at a mobile device, a first signal from a point-of-sale station;
transmitting, by the mobile device, via a mobile network, the first signal to a payment-authorization center;
receiving, at the mobile device, via the mobile network, a second signal from the payment-authorization center;
transmitting, by the mobile device, the second signal to the point-of-sale station.

22. The method of claim 21, further comprising the step of encrypting, by the mobile device, the first signal, prior to transmitting the first signal to the payment-authorization center.

23. The method of claim 22, further comprising the step of decrypting, by the mobile device, the second signal, prior to transmitting the second signal to the point-of-sale station.

24. The method of claim 21, further comprising the step of receiving, by the mobile device, a transaction reference number from the payment-authorization center.
